(19) United States
(12) Patent Application Publication
(10) Pub. No.: US 2024/0306142 A1
(43) Pub. Date: Sep. 12, 2024

(54) UU BASED V2N2V SIDELINK COMMUNICATIONS

(71) Applicant: QUALCOMM Incorporated, San Diego, CA (US)

(72) Inventors: Anantharaman BALASUBRAMANIAN, San Diego, CA (US); Shuanshuan WU, San Diego, CA (US)

(21) Appl. No.: 18/179,225

(22) Filed: Mar. 6, 2023

(51) Int. Cl. H04W 72/121; H04W 72/51

(52) U.S. Cl. CPC H04W 72/121; H04W 72/51

(57) ABSTRACT

A method for wireless communication at a first user equipment (UE) and related apparatus are provided. In the method, the first UE transmits, for a first network entity, an indication of a group identifier (ID) associated with communication between a group of UEs. The group of UEs includes the first UE and at least one second UE, and the group ID is associated with an identification of the at least one second UE by the first network entity via a second network entity. The first UE further communicates, based on the group ID, with the at least one second UE through a UE-Universal Mobile Telecommunications System (UMTS) connection via the first network entity and the second network entity. The method facilitates the connection among UEs served by different cells and improves the efficiency of wireless communication.

### TECHNICAL FIELD

The present disclosure relates generally to communication systems, and more particularly, to methods for vehicle-to-network-to-vehicle (V2N2V) sidelink communications using a user equipment (UE)-Universal Mobile Telecommunications System (UMTS) communication framework.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a first user equipment (UE). The apparatus may include memory and at least one processor coupled to the memory. Based at least in part on information stored in the memory, the at least one processor may be configured to transmit, for a first network entity, an indication of a group identifier (ID) associated with communication between a group of UEs, where the group of UEs includes the first UE and at least one second UE, and the group ID is associated with an identification of the at least one second UE by the first network entity via a second network entity; and communicate, based on the group ID, with the at least one second UE through a UE-Universal Mobile Telecommunications System (UMTS) (Uu) connection via the first network entity and the second network entity.

In an aspect of the disclosure, a method, a computer-readable medium, and an apparatus are provided for wireless communication at a first network entity. The apparatus may include memory and at least one processor coupled to the memory. Based at least in part on information stored in the memory, the at least one processor may be configured to receive, from a first UE, a first indication of a group ID associated with the first communication between a group of UEs, where the group of UEs includes the first UE and at least one second UE, and the group ID is associated with an identification of the at least one second UE by the first network entity via a second network entity; and transmit, for the second network entity, a second indication of the group ID, where the second indication of the group ID is associated with second communication between the first UE and the at least one second UE through the Uu connection via the first network entity and the second network entity.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example application of sidelink communication based on a Uu communication framework in accordance with various aspects of the present disclosure.

FIG. 5 is a call flow diagram illustrating a method of wireless communication in accordance with various aspects of the present disclosure.

FIG. 6 is a flowchart illustrating methods of wireless communication at a UE in accordance with various aspects of the present disclosure.

FIG. 7 is a flowchart illustrating methods of wireless communication at a UE in accordance with various aspects of the present disclosure.

FIG. 8 is a flowchart illustrating methods of wireless communication at a network entity in accordance with various aspects of the present disclosure.

FIG. 9 is a flowchart illustrating methods of wireless communication at a network entity in accordance with various aspects of the present disclosure.

FIG. 10 is a diagram illustrating an example of a hardware implementation for an example apparatus and/or network entity.

FIG. 11 is a diagram illustrating an example of a hardware implementation for an example network entity.

### DETAILED DESCRIPTION

Various aspects relate generally to a communication system. Some aspects more specifically relate to methods for V2N2V sidelink communications based on a Uu communication framework. In some examples, a first UE transmits, for a first network entity, an indication of a group ID associated with communication between a group of UEs. The group of UEs includes the first UE and at least one second UE, and the group ID is associated with an identification of the at least one second UE by the first network entity via a second network entity. The first UE further communicates, based on the group ID, with the at least one second UE through a Uu connection via the first network entity and the second network entity. In some examples, the indication of the group ID may be transmitted to the first network entity via a medium access control (MAC)-control element (MAC-CE) or a radio resource control (RRC) message.

Particular aspects of the subject matter described in this disclosure can be implemented to realize one or more of the following potential advantages. In some examples, by transmitting an indication of a group ID associated with communication between a group of UEs for a first network entity, where the group of UEs includes the first UE and at least one second UE, and the group ID is associated with an identification of the at least one second UE by the first network entity via a second network entity, and communicating, based on the group ID, with the at least one second UE through a Uu connection via the first network entity and the second network entity, the described techniques can be used to realize connected groupcast/unicast via a Uu communication framework. The described techniques facilitate the connection among UEs served by different cells and improve the efficiency of wireless communication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

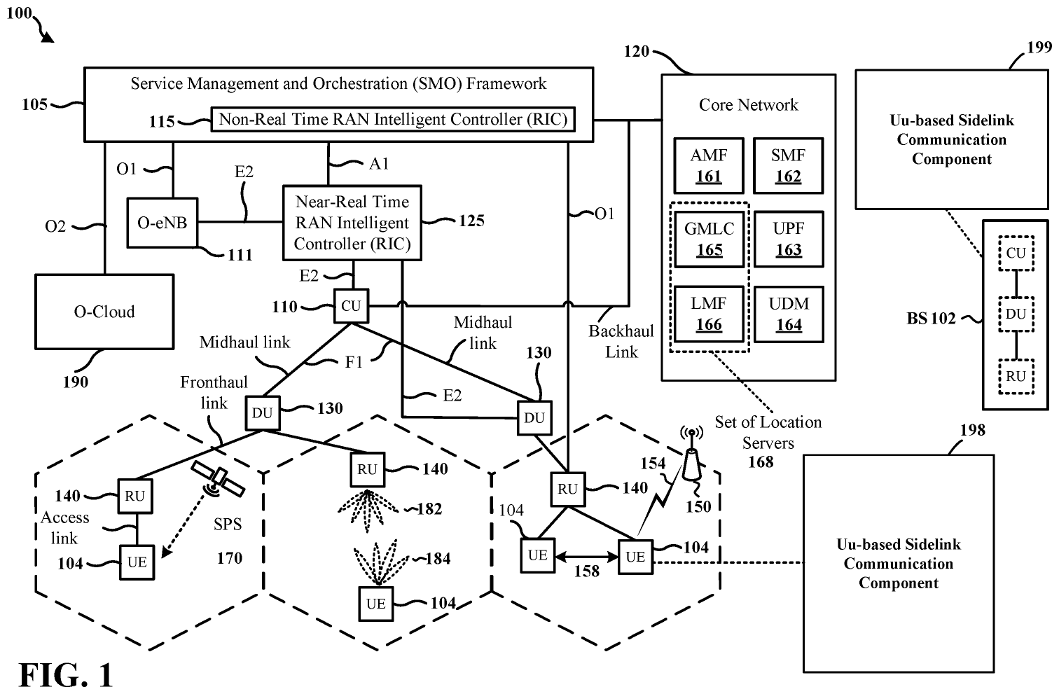

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHZ-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2. FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a Uu-based sidelink communication component 198. The Uu-based sidelink communication component may be configured to transmit, for a first network entity, an indication of a group ID associated with communication between a group of UEs, where the group of UEs includes the first UE and at least one second UE, and the group ID is associated with an identification of the at least one second UE by the first network entity via a second network entity; and communicate, based on the group ID, with the at least one second UE through a Uu connection via the first network entity and the second network entity. In certain aspects, the base station 102 may include a Uu-based sidelink communication component 199. The Uu-based sidelink communication component 199 may be configured to receive, from a first UE, a first indication of a group ID associated with the first communication between a group of UEs, where the group of UEs includes the first UE and at least one second UE, and the group ID is associated with an identification of the at least one second UE by the first network entity via a second network entity; and transmit, for the second network entity, a second indication of the group ID, where the second indication of the group ID is associated with second communication between the first UE and the at least one second UE through a Uu connection via the first network entity and the second network entity. Although the following description may be focused on 5G NR, the concepts described herein may be applicable to other similar areas, such as LTE, LTE-A, CDMA, GSM, and other wireless technologies.

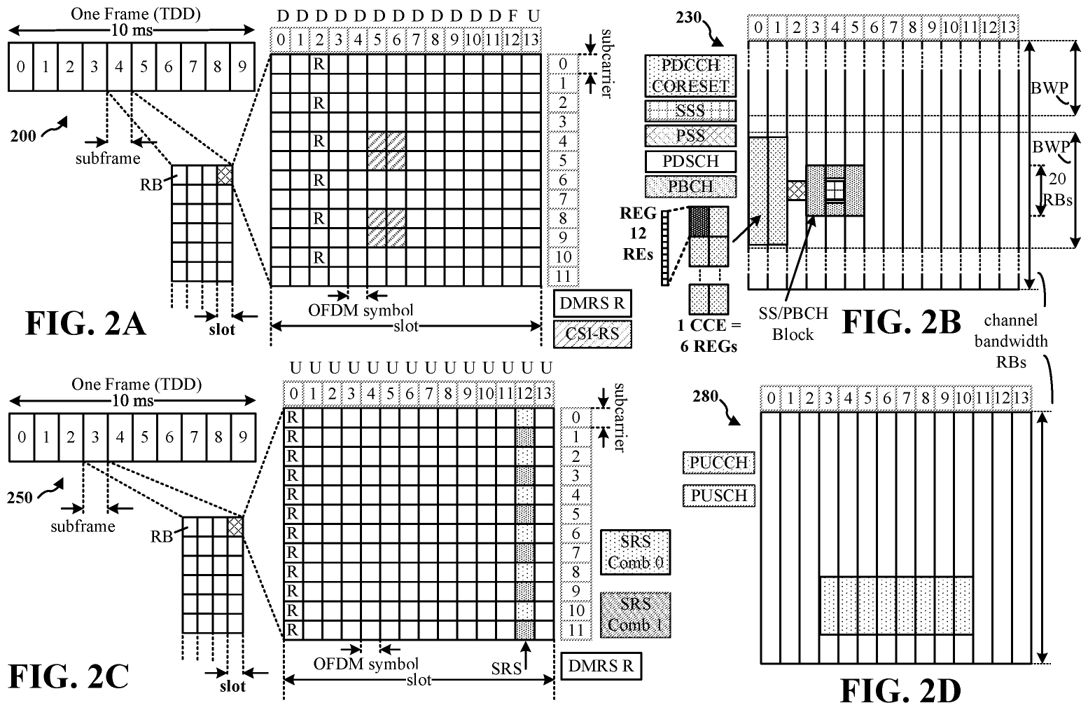

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ} *15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

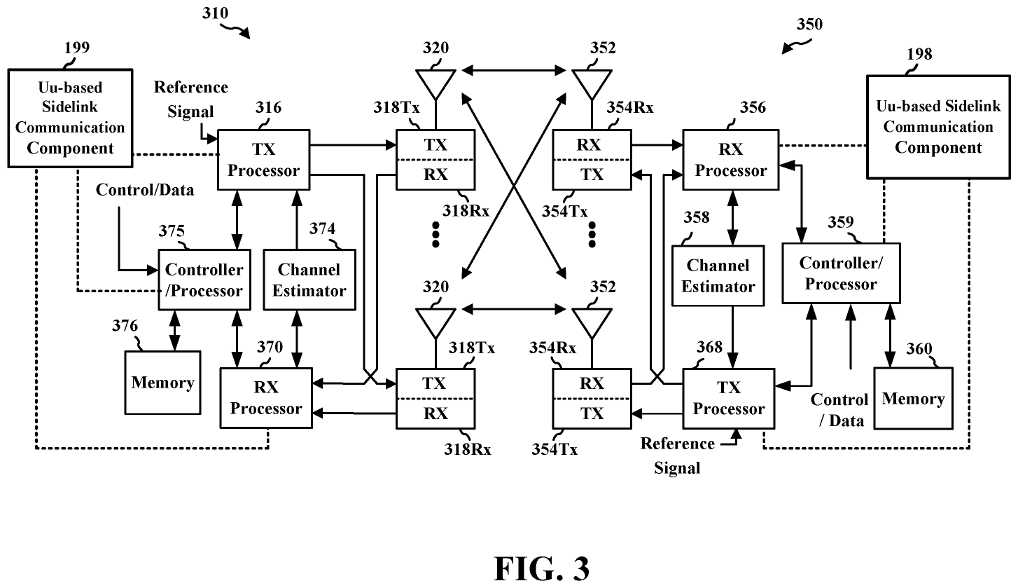

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the Uu-based sidelink communication component 198 of FIG. 1.

At least one of the TX processor 316, the RX processor 370, and the controller/processor 375 may be configured to perform aspects in connection with the Uu-based sidelink communication component 199 of FIG. 1.

Sidelink communication may support different communication types, such as unicast (communication between one transmitter and one receiver), groupcast (communication between one transmitter and a group of predetermined receivers), and broadcast (communication between one transmitter and all possible receivers within a transmission range). The group communication may be further categorized as connected groupcast and connectionless groupcast. In connected groupcast communications, a dedicated session may be established at the higher layer, and the UEs participating in the groupcast may share a common destination ID. In connectionless groupcast communications, a session may not be established at the higher layer, and the transmit UE may not be aware of possible receive UEs. On the other hand, the transmit UE may address possible receive UEs based on a range/distance of the possible receive UEs from the transmit UE. Unicast is similar to the connected groupcast scenario where the number of UEs in the group is one. Unicast/groupcast (connected) communications may happen in Mode-1 (where the network may assign resources to the UEs to perform sidelink communications) and Mode-2 (where the UEs may choose resources for communications based on a pool provided by the network).

The present disclosure provides methods and apparatus to realize sidelink communication using a Uu communication framework. The realized sidelink communication may be applicable to both Mode-1 and Mode-2. In some examples, the realized sidelink communication may provide vehicle-to-everything (V2X) and vehicle-to-network-to-vehicle (V2N2V) services.

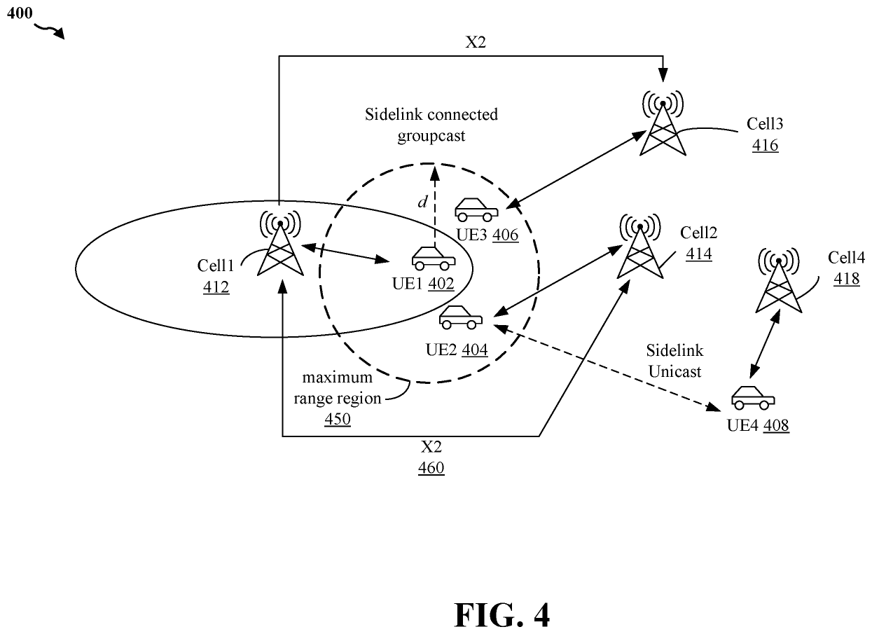

FIG. 4 is a diagram 400 illustrating an example application of sidelink communication based on a Uu communication framework (e.g., Uu network) in accordance with various aspects of the present disclosure. In some aspects, the Uu communication framework may be based on the terrestrial radio access network (TRAN). In some aspects, the Uu communication framework may be based on non-terrestrial networks, such as satellite networks. The example of FIG. 4 may include a group of four UEs (e.g., UE1 402, UE2 404, UE3 406, and UE4 408). These four UEs (UE1 402, UE2 404, UE3 406, and UE4 408) may be under the coverage of four cells or base stations (e.g., cell1 412, cell2 414, cell3 416, and cell4 418), respectively. As used herein, the term “cell” may refer to a network node, a network entity, a mobility element of a network, a RAN node, a core network node, a network element, or network equipment, such as a base station, or one or more units (or one or more components) performing base station functionality.

In one example, the first UE (UE1 402) may perform sidelink connected groupcast communication via a Uu framework with other UEs, such as UE2 404 and UE3 406. In this case, UE1 402 may be referred to as the transmit UE (Tx UE), and UE2 404 and UE3 406 may be referred to as the receive UEs (Rx UEs). The Tx UE may communicate with the Rx UEs via Uu communications for connected groupcast. In another example, UE2 404 may use the available Uu network to realize sidelink unicast with UE4 408. In this case, UE2 404 may be the Tx UE, and UE 4 408 may be the Rx UE.

To realize these communications, the cell serving the Tx UE may communicate with other cells so that they can deliver the sidelink messages from the Tx UE to the relevant Rx UEs in its coverage area. Referring to FIG. 4, in the example of UE1 402 being the Tx UE, and UE2 404 and UE3 406 being the Rx UEs, cell1 412 (the cell serving UE1 402) may communicate with cell2 414 and cell3 416 (the cells serving UE2 404 and UE3 406, respectively) to deliver the sidelink message from the Tx UE (UE1 402) to the Rx UEs (UE2 404 and UE3 406).

Additionally, group management may be performed, for example, when an existing UE leaves the group or a new UE joins the group. In this case, the cell corresponding to Tx UE may maintain a list of cells associated with an Rx UE in its coverage area and is involved in the groupcast/unicast communication.

In some aspects, to realize the connected groupcast/unicast via a Uu connection, a Tx UE may signal to its serving cell to enable the serving cell to determine the cells of Rx UEs involved in connected groupcast.

The serving cell of the Tx UE may determine the serving cells of the Rx UEs in various ways. In one example, the serving cell (e.g., cell1 412 in FIG. 4, assuming UE1 402 is a Tx UE) of the Tx UE may determine the serving cells of the Rx UEs involved in sidelink connected groupcast by leveraging the destination ID transmitted to it by the Tx UE (UE1 402) as a part of a V2N2V transmission. As used here, the serving cell of the Tx UE may be referred to as a “Tx cell,” and the serving cell of the Rx UE may be referred to as an “Rx cell.”

In one example, the destination ID may be transmitted by the Tx UE (UE1 402) as a part of MAC-CE explicitly indicating that the destination ID is a part of the V2N2V transmission. In one example, the destination ID may be transmitted as a part of RRC. If the Tx UE (UE1 402) performs an “RRC Connection Request” (i.e., transmits a message named “RRC Connection Request”), the destination ID may be indicated as a part of “V2N2V Establishment Cause” (i.e., a field named “V2N2V Establishment Cause”) in the “RRC Connection Request.”

Using the destination ID obtained from the Tx UE (e.g., UE1 402), the Tx cell may determine the Rx cells involved in the sidelink connected groupcast/unicast based on the destination ID.

The Tx cell may determine the Rx cells in various ways. In one example, the Tx cell may determine the current location of the Tx UE (e.g., UE1 402) using, for example, downlink/uplink positioning techniques. Then, the Tx cell (cell1 412) may use the maximum possible range of sidelink communication to determine the region where the possible Rx UEs may be located. Then, the Tx cell may determine possible serving cells (possible Rx cells) of all possible Rx UEs that are within the maximum possible range of the Tx UE (UE1 402).

For example, referring to FIG. 4, a maximum range region 450, with a radius d (d may be the maximum sidelink range) and the Tx UE (UE1 402) as the center, may be used to determine the region where the possible Rx UEs may be located. In the example of FIG. 4, UE2 404, and UE3 406 are the possible Rx UEs, as they are located within the maximum range region 450. The Tx cell (cell1 412) then may determine possible serving cells of the Rx UEs (UE2 404 and UE3 406) as the Rx cells.

In another example, the Tx cell (cell1 412) may be preconfigured with a set of possible cells that may be the serving cells of possible Rx UEs that can be served by the Tx UE (UE1 402). In one example, the set of possible cells may be obtained by taking the maximum range of the cell edge of the Tx UE (UE1 402).

After the possible Rx cells are determined, the Tx cell (cell1 412) may transmit the destination ID of Rx UEs (or group ID) to the possible Rx cells. The destination ID may inform the possible Rx cells of the sidelink destination ID for the V2N2V communication.

Upon receiving the destination ID, the Rx cells may signal the destination ID to the corresponding Rx UEs. In one example, the Rx cells may transmit the destination ID as a part of DCI. The DCI carrying the destination ID for V2N2V may be scrambled with one or more of the cell radio network temporary identifier (C-RNTI), the temporary C-RNTI (TC-RNTI), or the paging RNTI. For example, if the Rx UE is in the RRC idle (RRC_IDLE) mode, the corresponding Rx cell may wake up the Rx UE in order to receive the V2N2V message. In one example, the paging message may indicate whether the corresponding UE is woken up for V2N2V communication or for non-V2N2V communication (e.g., typical downlink communication).

The Rx cells may scramble the PDSCH of the V2N2V communication. That is, the Rx cells may use a random sequence (e.g., the scrambling sequence) to scramble the data bits of the V2N2V communication in the PDSCH. The scrambling sequence for each Rx UE may be unique to prevent interference between the UEs.

The Rx cells may scramble the PDSCH of the V2N2V communication in various ways. In one example, the Rx cells may scramble the PDSCH of the V2N2V communication based on the destination ID of the Rx UEs. In another example, for unicast communications, the scrambling sequence used for scrambling the PDSCH may be based on the destination ID or a combination (or a function) of the both source ID and the destination ID (as both the source ID and the destination ID are known to the transmitter and the receiver in unicast). In yet another example, the Rx cells may scramble the PDSCH of the V2N2V communication based on a common sequence known by the sidelink group or for sidelink unicast communication.

When the Rx cells scramble the PDSCH of the V2N2V communication, in one example, the scrambling sequence used for the PDSCH could be based on a preconfigured base sequence b. The scrambling sequence \tilde{b} used for transmitting data for V2N2V via PDSCH may be a function of the destination ID, and the source/destination ID. That is, \tilde{b}=f(b, ID), where ID could be one or more of the source ID, the destination ID, or the group ID. In another example, the scrambling sequence used for the PDSCH may be based on the group ID (for connected groupcast) and a combination of the source ID and the destination ID (for unicast). In some examples, the group ID, the source ID, or the destination ID may itself be used as the scrambling sequence for scrambling the PDSCH.

In some aspects, the group members (e.g., UEs and cells) that are involved in the V2N2V communication may change. For example, new Rx UEs belonging to different cells may join the sidelink groupcast, and existing member UEs of the sidelink groupcast may move out of the groupcast due to, for example, the mobility of the UE(s). In one case, the serving cell of a member UE of the groupcast may change (handover) from a first cell to a second cell.

Example aspects presented herein provide dynamic group configuration signaling for V2N2V communication to address the signaling exchanges involved in V2N2V due to the changes in group members in connected groupcast.

One example of dynamic group configuration signaling is directed to the handover intimation by Rx cells to the Tx cell. For example, when one or more Rx UEs have their serving cell handover from its current serving cell (e.g., the first Rx cell) to the second Rx cell, the first Rx cell may indicate to the Tx cell over the X2 interface (an interface that connects two cells and allows the two cells to exchange data and control directly with each other) that this particular Rx UE has handed over from the first Rx cell to the second Rx cell. Upon receiving this indication, the Tx cell may transmit the V2N2V message to the second Rx cell (if the Tx cell does not originally transmit to the second Rx cell). For example, as shown in FIG. 4, if the second UE (UE2 404) has a serving cell handover from cell2 414 to cell4 418, the original serving cell (cell2 414) of UE2 404 may indicate to the Tx cell (cell1 412), via the X2 interface 460, the handover. Upon receiving the indication of the handover, the Tx cell (cell1 412) may transmit the V2N2V message to the new serving cell of UE2 404, which is cell4 418. In another example, the Tx UE (e.g., UE1 402) may indicate to the Tx cell (e.g., cell1 412) the change in group size (e.g., known to Tx UE by a higher layer). Upon receiving the message about the change in group size, the Tx cell (cell1 412) may transmit the V2N2V message of the Tx UE (UE1 402) to a more extensive set of cells (e.g., from the preconfigured set) than it currently does. For example, when a Tx UE (e.g., UE1 402) is performing groupcast with Rx UEs that all belong to the same Tx cell (e.g., cell1 412), the V2N2V message may not be transmitted to other cells. Upon receiving the message of the group size change from the Tx UE (e.g., UE1 402), the Tx cell may (cell1 412) transmit the V2N2V message to its neighboring cells (e.g., from the preconfigured set) with the expectation that the new Rx UEs may be served by one or more of its neighboring cells.

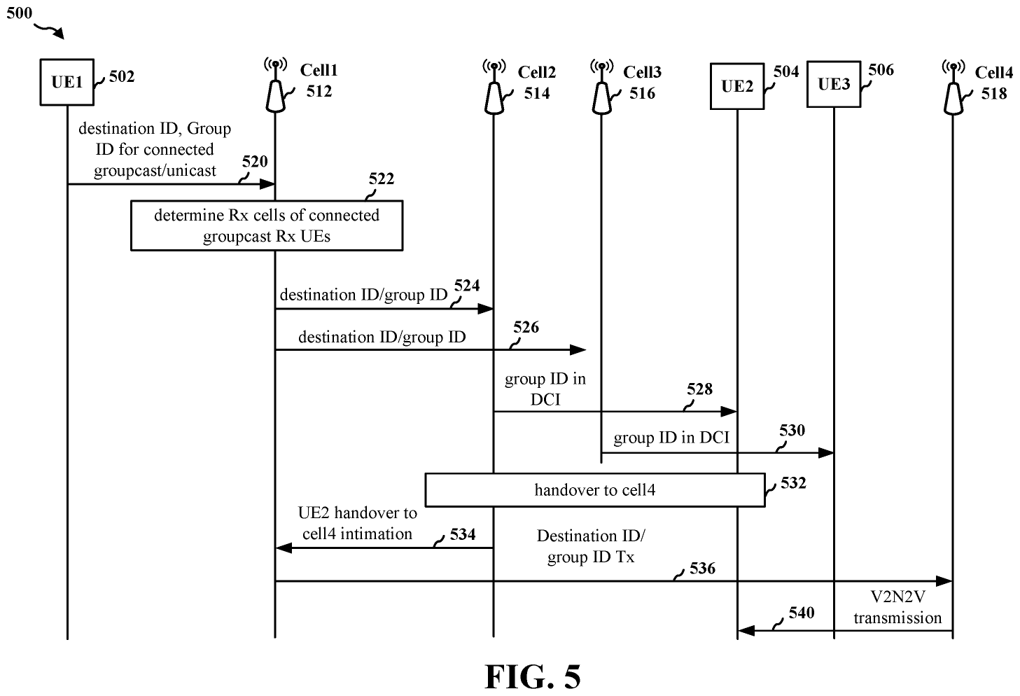

FIG. 5 is a call flow diagram 500 illustrating a method of wireless communication in accordance with various aspects of this present disclosure. Although aspects are described for a cell 512, the aspects may be performed by a base station in aggregation and/or by one or more components of a cell 512 (e.g., such as a CU 110, a DU 130, and/or an RU 140).

As shown in FIG. 5, at 520, a first UE 502 may transmit a destination ID (or group ID) for connected groupcast/unicast to a first cell 512. For example, referring to FIG. 4, a UE1 402 may transmit a destination ID (or group ID) for connected groupcast/unicast to a first cell (cell1 412).

At 522, the first cell 512 may determine Rx cells of connected groupcast Rx UEs based on the received destination ID (or group ID) for connected groupcast/unicast from the first UE 502. For example, referring to FIG. 4, the cell1 412 may determine Rx cells of connected groupcast Rx UEs based on the received destination ID (or group ID) for connected groupcast/unicast from the UE1 402.

The first cell 512 may transmit the destination ID (or group ID) to the Rx cells determined on 522. For example, the Rx cells may be cell2 514 and cell3 516, and the first cell 512 may transmit the destination ID (or group ID) to cell2 514 at 524, and to cell3 516 at 526.

The Rx cells may transmit the destination ID (or group ID) to the corresponding UEs. For example, cell2 514 may transmit the destination ID (or group ID) to UE2 504 at 528, and cell3 516 may transmit the destination ID (or group ID) to UE3 506 at 530.

In some examples, UE2 504 may have its serving cell handover, at 532, from cell2 514 to, for example, cell4 518. In that case, cell2 514 may transmit, at 534, to the Tx cell (cell1 512) an indication of the handover to cell4 518. Upon receiving the indication of the handover from cell2 514 at 534, the Tx cell (cell1 512) may transmit the destination ID (or group ID) to the new serving cell of UE2 504 (cell4 518) at 536, and the new serving cell of UE2 504 (cell4 518) may transmit the V2N2V message to UE2 504 at 540.

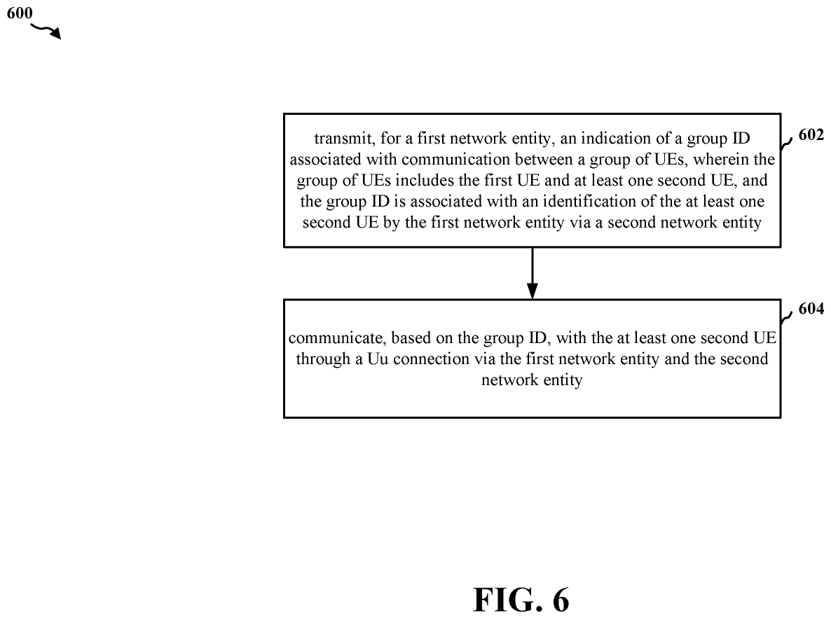

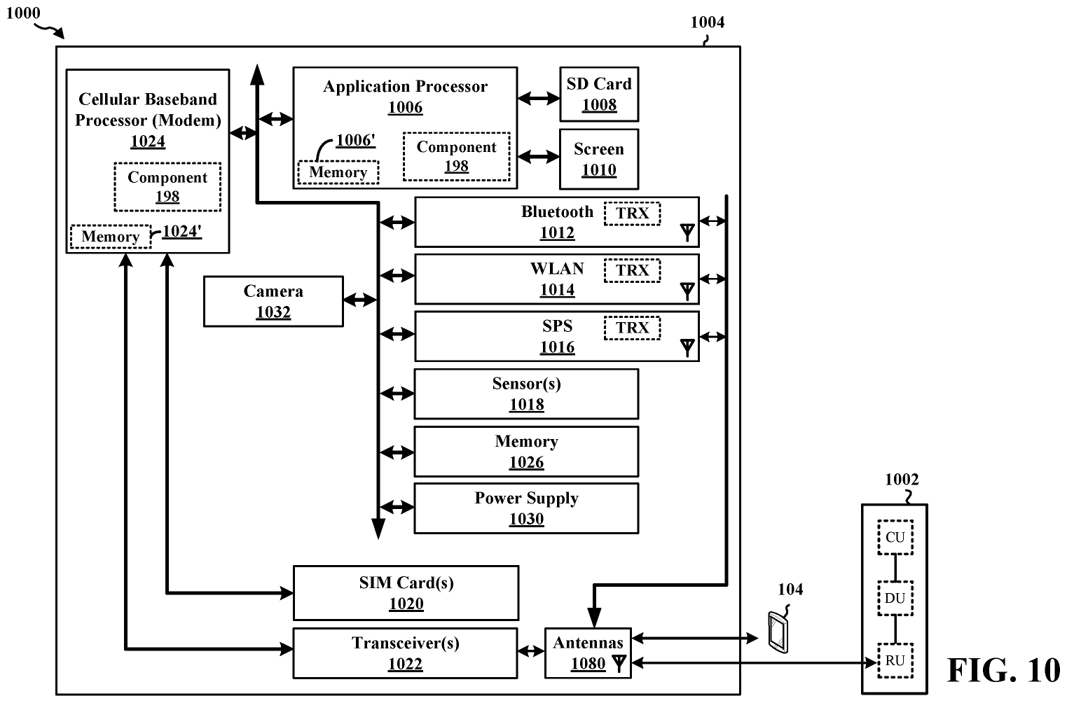

FIG. 6 is a flowchart 600 illustrating methods of wireless communication at a first UE in accordance with various aspects of the present disclosure. The method may be performed by the first UE. The first UE may be the UE 104, 350, 402, 502, or the apparatus 1004 in the hardware implementation of FIG. 10. The method enables a UE to transmit a destination ID to its serving cell to establish a connected groupcast or unicast with UEs served by other cells. The method facilitates the connection among UEs served by different cells and improves the efficiency of wireless communication.

As shown in FIG. 6, at 602, the first UE may transmit, for a first network entity, an indication of a group ID associated with communication between a group of UEs. The group of UEs may include the first UE and at least one second UE, and the group ID may be associated with an identification of the at least one second UE by the first network entity via a second network entity. The first network entity may be a base station, or a component of a base station, in the access network of FIG. 1 or a core network component (e.g., base station 102, 310; cell1 412, 512; or the network entity 1002 in the hardware implementation of FIG. 10). FIGS. 4 and 5 illustrate various aspects of the steps in connection with flowchart 600. For example, referring to FIG. 5, the first UE 502 may transmit, at 520, for a first network entity (cell1 512), an indication of a group ID associated with communication between a group of UEs. Referring to FIG. 4, the group of UEs may include the first UE (UE1 402) and at least one second UE (e.g., UE2 404). The group ID may be associated with an identification of the at least one second UE (e.g., UE2 404) by the first network entity (e.g., cell1 412) via a second network entity (e.g., cell2 414). The second network entity may be a base station, or a component of a base station, in the access network of FIG. 1 or a core network component (e.g., base station 102, 310; cell2 414, 514; or the network entity 1002 in the hardware implementation of FIG. 10). In some aspects, 602 may be performed by the Uu-based sidelink communication component 198.

At 604, the first UE may communicate, based on the group ID, with the at least one second UE through a Uu connection via the first network entity and the second network entity. For example, referring to FIG. 5, the first UE 502 may communicate, based on the group ID, with the at least one second UE (UE2 504) through a Uu connection via the first network entity (cell1 512) and the second network entity (cell2 514). Referring to FIG. 4, the first UE (UE1 402) may communicate, based on the group ID, with the at least one second UE (e.g., UE2 404) through a Uu connection via the first network entity (cell1 412) and the second network entity (cell2 414). In some aspects, 604 may be performed by the Uu-based sidelink communication component 198.

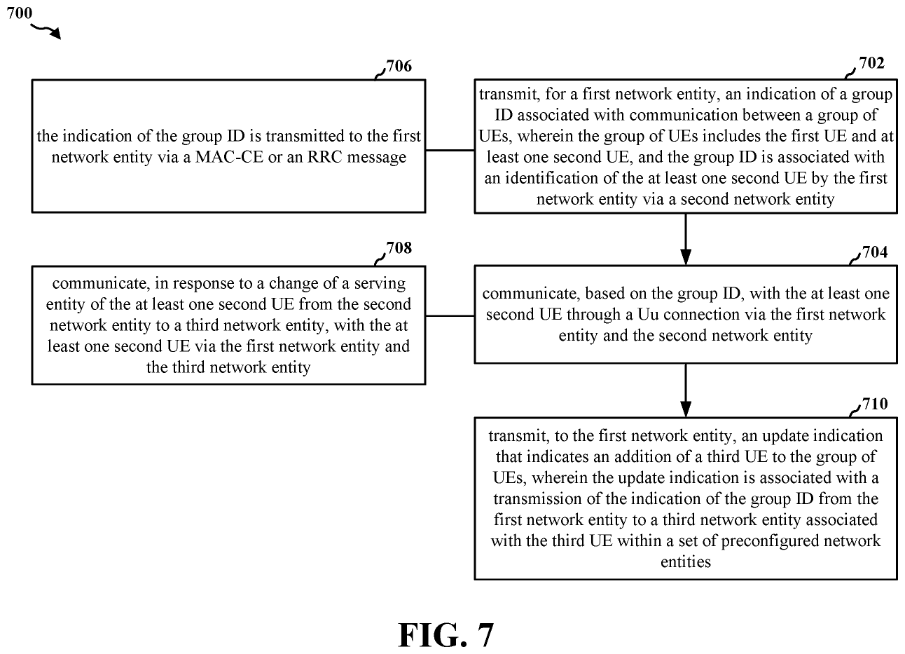

FIG. 7 is a flowchart 700 illustrating methods of wireless communication at a first UE in accordance with various aspects of the present disclosure. The method may be performed by the first UE. The UE may be the UE 104, 350, 402, 502, or the apparatus 1004 in the hardware implementation of FIG. 10. The method enables a UE to transmit a destination ID to its serving cell to establish a connected groupcast or unicast with UEs served by other cells. The method facilitates the connection among UEs served by different cells and improves the efficiency of wireless communication.

As shown in FIG. 7, at 702, the first UE may transmit, for a first network entity, an indication of a group ID associated with communication between a group of UEs. The group of UEs may include the first UE and at least one second UE, and the group ID is associated with an identification of the at least one second UE by the first network entity via a second network entity. The first network entity may be a base station, or a component of a base station, in the access network of FIG. 1 or a core network component (e.g., base station 102, 310; cell1 412, 512; or the network entity 1002 in the hardware implementation of FIG. 10). FIGS. 4 and 5 illustrate various aspects of the steps in connection with flowchart 700. For example, referring to FIG. 5, the first UE 502 may transmit, at 520, for a first network entity (cell1 512), an indication of a group ID associated with communication between a group of UEs. Referring to FIG. 4, the group of UEs may include the first UE (UE1 402) and at least one second UE (e.g., UE2 404, UE3 406). The group ID may be associated with an identification of the at least one second UE (e.g., UE2 404) by the first network entity (e.g., cell1 412) via a second network entity (e.g., cell2 414). In some aspects, 702 may be performed by the Uu-based sidelink communication component 198.

At 704, the first UE may communicate, based on the group ID, with the at least one second UE through a Uu connection via the first network entity and the second network entity. For example, referring to FIG. 5, the first UE 502 may communicate, based on the group ID, with the at least one second UE (UE2 504) through a Uu connection via the first network entity (cell1 512) and the second network entity (cell2 514). Referring to FIG. 4, the first UE (UE1 402) may communicate, based on the group ID, with the at least one second UE (e.g., UE2 404) through a Uu connection via the first network entity (cell1 412) and the second network entity (cell2 414). In some aspects, 704 may be performed by the Uu-based sidelink communication component 198.

In some aspects, at 706, the indication of the group ID may be transmitted to the first network entity via a MAC-CE or an RRC message. For example, referring to FIG. 5, when the first UE 502 transmits, at 520, the indication of the destination ID or the group ID, the indication of the group ID may be transmitted to the first network entity (cell1 512) via a MAC-CE or an RRC message. In some aspects, 706 may be performed by the Uu-based sidelink communication component 198.

In some aspects, prior to the group ID being associated with the identification of the at least one second UE, the first network entity is associated with the identification of the second network entity. For example, referring to FIG. 4, prior to the group ID being associated with the identification of the at least one second UE (e.g., UE2 404), the first network entity (cell1 412) may be associated with the identification of the second network entity (cell2 414).

In some aspects, the identification of the second network entity may be associated with: a first determination of a current location of the first UE, a second determination of, based on the current location of the first UE and a sidelink range of the first UE, a region for the at least one second UE, and the identification of, based on the region, the second network entity. For example, referring to FIG. 4, the identification of the second network entity (cell2 414) may be associated with: a first determination of a current location of the first UE (UE1 402), a second determination of, based on the current location of the first UE (UE1 402) and a sidelink range (e.g., radius d) of the first UE (UE1 402), a region (e.g., the maximum range region 450) for the at least one second UE (e.g., UE2 404), and the identification of, based on the region (e.g., the maximum range region 450), the second network entity (cell2 414).

In some aspects, the identification of the second network entity may be associated with the identification of the second network entity from a set of preconfigured network entities. For example, referring to FIG. 5, the first network entity (cell1 512) may be configured with a set of network entities, and the identification of the second network entity (cell2 514) may be associated with the identification of one network entity from the set of preconfigured network entities.

In some aspects, the identification of the second network entity from the set of preconfigured network entities may be based on a maximum range of the first UE. For example, referring to FIG. 4, the identification of the second network entity (cell2 414) from the set of preconfigured network entities may be based on a maximum range (e.g., radius d) of the first UE (UE1 402). That is, the second network entity (cell2 414) may be a network entity in the set of preconfigured network entities that has a UE located within the maximum range region 450 defined by the radius d and the location of the first UE (UE1 402).

In some aspects, the identification of the at least one second UE by the first network entity via the second network entity is associated with: a transmission of the indication of the group ID to the second network entity to cause the second network entity to transmit the group ID to the at least one second UE. For example, referring to FIG. 5, the identification of the at least one second UE (UE2 504) by the first network entity (cell1 512) via the second network entity (cell2 514) may be associated with a transmission (at 524) of the indication of the group ID to the second network entity (cell2 514) to cause the second network entity (cell2 514) to transmit the group ID to the at least one second UE (UE2 504) at 528. Referring to FIG. 4, the identification of the at least one second UE (UE2 404) by the first network entity (cell1 412) via the second network entity (cell2 414) may be associated with: a transmission of the indication of the group ID to the second network entity (cell2 414) to cause the second network entity (cell2 414) to transmit the group ID to the at least one second UE (UE2 404).

In some aspects, the group ID may be transmitted to the at least one second UE via DCI. For example, referring to FIG. 5, when the second network entity (cell2 514) transmits, at 528, the group ID to the second UE (UE2 504), the group ID may be transmitted to the at least one second UE (UE2 504) via DCI.

In some aspects, the DCI may be scrambled with one or more of: a C-RNTI, a TC-RNTI, or a paging RNTI. For example, referring to FIG. 5, when the second network entity (cell2 514) transmits, at 528, the group ID to the second UE (UE2 504) through DCI, the DCI may be scrambled with one or more of: a C-RNTI, a TC-RNTI, or a paging RNTI.

In some aspects, the scrambling sequence for a PDSCH between the first UE and the at least one second UE is based on at least one of: the group ID or a combination of the group ID and a source ID associated with the first UE, or a common sequence known to the first UE and the at least one second UE. For example, referring to FIG. 5, the scrambling sequence for a PDSCH between the first UE (UE1 502) and the at least one second UE (e.g., UE2 504) may be based on at least one of: the group ID (at 520 and 524) or a combination of the group ID and a source ID associated with the first UE (UE1 502), or a common sequence known to the first UE (UE1 502) and the at least one second UE (UE2 504).

In some aspects, to communicate with the at least one second UE via the first network entity and the second network entity, the first UE may be configured to: communicate, at 708, in response to a change of a serving entity of the at least one second UE from the second network entity to a third network entity, with the at least one second UE via the first network entity and the third network entity. For example, referring to FIG. 5, to communicate with the at least one second UE (UE2 504) via the first network entity (cell1 512) and the second network entity (cell2 514), the first UE (UE1 502) may be configured to: communicate, in response to a change of a serving entity of the at least one second UE (UE2 504) from the second network entity (cell2 514) to another network entity (e.g., cell4 518), with the at least one second UE (UE2 504) via the first network entity (cell1 512) and the other network entity (e.g., cell 4 518). In some aspects, 708 may be performed by the Uu-based sidelink communication component 198.

At 710, the first UE may transmit, to the first network entity, an update indication that indicates an addition of a third UE to the group of UEs. The update indication may be associated with a transmission of the indication of the group ID from the first network entity to a third network entity associated with the third UE within a set of preconfigured network entities. For example, referring to FIG. 4, the first UE (UE1 402) may transmit, to the first network entity (cell1 412), an update indication that indicates an addition of a third UE (e.g., UE3 406) to the group of UEs. The update indication may be associated with a transmission of the indication of the group ID from the first network entity (cell1 412) to a third network entity (cell3 416) associated with the third UE (UE3 406) within a set of preconfigured network entities. Referring to FIG. 5, the first UE (UE1 502) may transmit, to the first network entity (cell1 512), an update indication that indicates an addition of a third UE (e.g., UE3 506) to the group of UEs. The update indication may be associated with a transmission, at 526, of the indication of the group ID from the first network entity (cell1 512) to a third network entity (cell3 516) associated with the third UE (UE3 506) within a set of preconfigured network entities. In some aspects, 710 may be performed by the Uu-based sidelink communication component 198.

In some aspects, the third network entity may be a serving entity of the third UE. For example, referring to FIG. 5, the third network entity (cell3 516) may be a serving entity of the third UE (UE3 506). Referring to FIG. 4, the third network entity (cell3 416) may be a serving entity of the third UE (UE3 406).

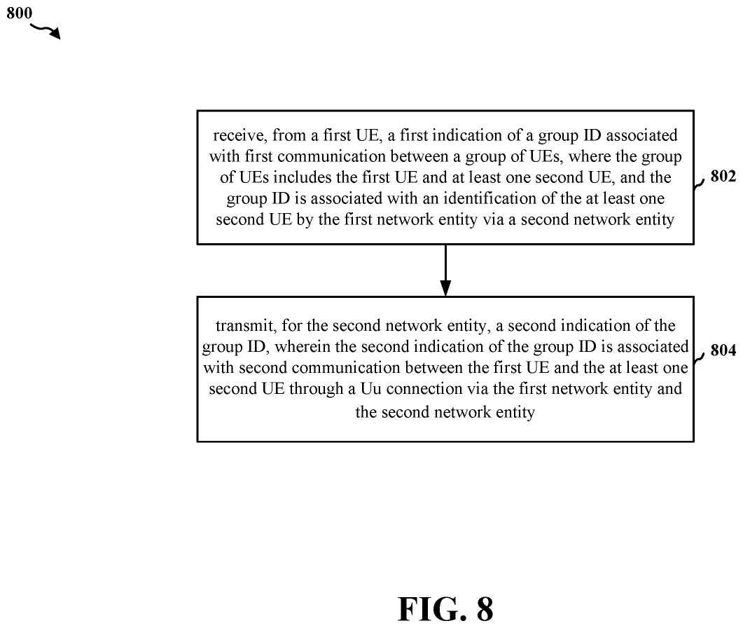

FIG. 8 is a flowchart 800 illustrating methods of wireless communication at a first network entity in accordance with various aspects of the present disclosure. The method may be performed by the first network entity. The first network entity may be a base station, or a component of a base station, in the access network of FIG. 1 or a core network component (e.g., base station 102, 310; cell1 412, 512; or the network entity 1002 in the hardware implementation of FIG. 10). The method enables a UE to transmit a destination ID to its serving cell to establish a connected groupcast or unicast with UEs served by other cells. The method facilitates the connection among UEs served by different cells and improves the efficiency of wireless communication.

As shown in FIG. 8, at 802, the first network entity may receive, from a first UE, a first indication of a group ID associated with the first communication between a group of UEs, where the group of UEs includes the first UE and at least one second UE, and the group ID is associated with an identification of the at least one second UE by the first network entity via a second network entity. The first UE may be the UE 104, 350, 402, 502, or the apparatus 1004 in the hardware implementation of FIG. 10. FIGS. 4 and 5 illustrate various aspects of the steps in connection with flowchart 800. For example, referring to FIG. 5, the first network entity (cell1 512) may revive, at 520, from the first UE (UE1 502), an indication of a group ID associated with communication between a group of UEs. Referring to FIG. 4, the group of UEs may include the first UE (UE1 402) and at least one second UE (e.g., UE2 404). The group ID may be associated with an identification of the at least one second UE (e.g., UE2 404) by the first network entity (e.g., cell1 412) via a second network entity (e.g., cell2 414). In some aspects, 802 may be performed by the Uu-based sidelink communication component 199.

At 804, the first network entity may transmit, for the second network entity, a second indication of the group ID. The second indication of the group ID may be associated with second communication between the first UE and the at least one second UE through a Uu connection via the first network entity and the second network entity. For example, referring to FIG. 5, the first network entity (cell1 512) may transmit, at 524, for the second network entity (cell2 514), a second indication of the group ID. The second indication of the group ID may be associated with second communication between the first UE (UE1 502) and the at least one second UE (e.g., UE2 504) through a Uu connection via the first network entity (cell1 512) and the second network entity (cell2 514). The second network entity may be a base station, or a component of a base station, in the access network of FIG. 1 or a core network component (e.g., base station 102, 310; cell2 414, 514; or the network entity 1002 in the hardware implementation of FIG. 10). In some aspects, 804 may be performed by the Uu-based sidelink communication component 199.

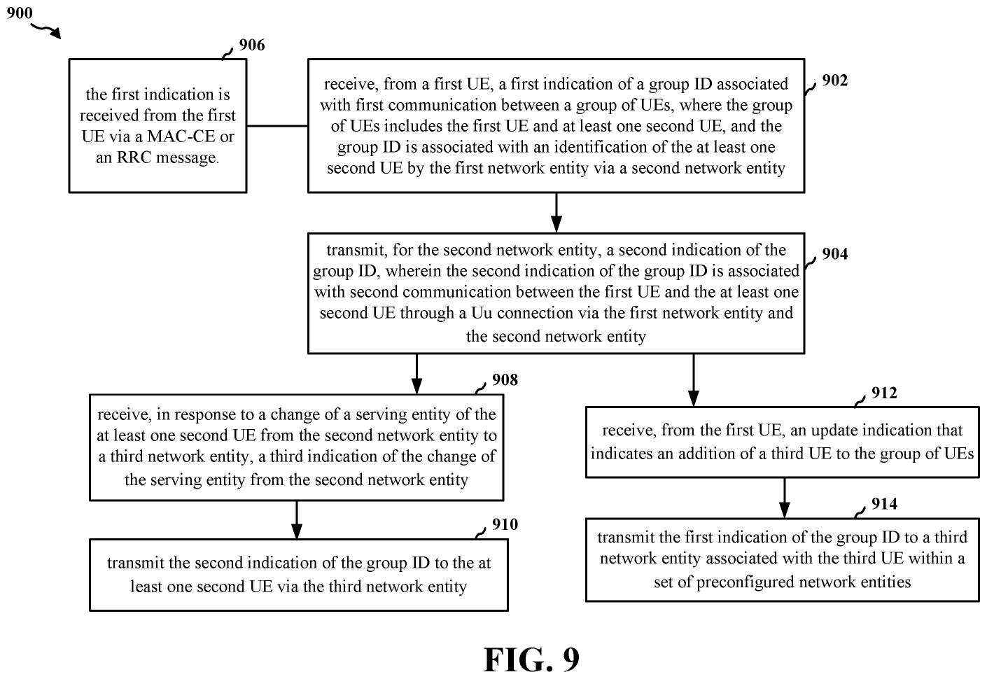

FIG. 9 is a flowchart 900 illustrating methods of wireless communication at a first network entity in accordance with various aspects of the present disclosure. The method may be performed by the first network entity. The first network entity may be a base station, or a component of a base station, in the access network of FIG. 1 or a core network component (e.g., base station 102, 310; cell1 412, 512; or the network entity 1002 in the hardware implementation of FIG. 10). The method enables a UE to transmit a destination ID to its serving cell to establish a connected groupcast or unicast with UEs served by other cells. The method facilitates the connection among UEs served by different cells and improves the efficiency of wireless communication.

As shown in FIG. 9, at 902, the first network entity may receive, from a first UE, a first indication of a group ID associated with the first communication between a group of UEs, where the group of UEs includes the first UE and at least one second UE, and the group ID is associated with an identification of the at least one second UE by the first network entity via a second network entity. The UE may be the UE 104, 350, 402, 502, or the apparatus 1004 in the hardware implementation of FIG. 10. FIGS. 4 and 5 illustrate various aspects of the steps in connection with flowchart 900. For example, referring to FIG. 5, the first network entity (cell1 512) may revive, at 520, from the first UE (UE1 502), an indication of a group ID associated with communication between a group of UEs. Referring to FIG. 4, the group of UEs may include the first UE (UE1 402) and at least one second UE (e.g., UE2 404). The group ID may be associated with an identification of the at least one second UE (e.g., UE2 404) by the first network entity (e.g., cell1 412) via a second network entity (e.g., cell2 414). In some aspects, 902 may be performed by the Uu-based sidelink communication component 199.

At 904, the first network entity may transmit, for the second network entity, a second indication of the group ID. The second indication of the group ID is associated with second communication between the first UE and the at least one second UE through a Uu connection via the first network entity and the second network entity. For example, referring to FIG. 5, the first network entity (cell1 512) may transmit, at 524, for the second network entity (cell2 514), a second indication of the group ID. The second indication of the group ID may be associated with second communication between the first UE (UE1 502) and the at least one second UE (e.g., UE2 504) through a Uu connection via the first network entity (cell1 512) and the second network entity (cell2 514). The second network entity may be a base station, or a component of a base station, in the access network of FIG. 1 or a core network component (e.g., base station 102, 310; cell2 414, 514; or the network entity 1002 in the hardware implementation of FIG. 10). In some aspects, 904 may be performed by the Uu-based sidelink communication component 199.

In some aspects, the first indication of the group ID may be identical to the second indication of the group ID. For example, referring to FIG. 5, the first indication of the group ID (at 520) may be identical to the second indication of the group ID (at 524).

In some aspects, the first indication of the group ID may be different from the second indication of the group ID. For example, referring to FIG. 5, the first indication of the group ID (at 520) may be different from the second indication of the group ID (at 524).

In some aspects, at 906, the first indication may be received from the first UE via a MAC-CE or an RRC message. For example, referring to FIG. 5, the first indication may be received, at 520, from the first UE (UE1 502) via a MAC-CE or an RRC message. In some aspects, 906 may be performed by the Uu-based sidelink communication component 199.

In some aspects, prior to the group ID being associated with the identification of the at least one second UE, the at least one processor is configured to identify the second network entity. For example, referring to FIG. 4, prior to the group ID being associated with the identification of the at least one second UE (e.g., UE2 404), the first network entity (cell1 412) may be associated with the identification of the second network entity (cell2 414).

In some aspects, to identify the second network entity, the first network entity may be configured to: determine a current location of the first UE, determine, based on the current location of the first UE and a sidelink range of the first UE, a region for the at least one second UE, and identify, based on the region, the second network entity. For example, referring to FIG. 4, to identify the second network entity (cell2 414), the first network entity (cell1 412) may be configured to: determine a current location of the first UE (UE1 402), determine, based on the current location of the first UE (UE1 402) and a sidelink range (e.g., radius d) of the first UE (UE1 402), a region (e.g., the maximum range region 450) for the at least one second UE (e.g., UE2 404), and identify, based on the region (e.g., the maximum range region 450), the second network entity (cell2 414).

In some aspects, to identify the second network entity, the first network entity may be configured to: identify the second network entity from a set of preconfigured network entities. For example, referring to FIG. 5, the first network entity (cell1 512) may be configured with a set of network entities, and the first network entity (cell1 512) may identify the second network entity (cell2 514) from the set of preconfigured network entities.

In some aspects, the second network entity may be identified from the set of preconfigured network entities based on a maximum range of the first UE. For example, referring to FIG. 4, the first network entity (cell1 412) may identify the second network entity (cell2 414) from the set of preconfigured network entities based on a maximum range (e.g., radius d) of the first UE (UE1 402). That is, the second network entity (cell2 414) may be a network entity in the set of preconfigured network entities that has a UE located within the maximum range region 450 defined by the radius d and the location of the first UE (UE1 402).

In some aspects, to identify the at least one second UE via the second network entity, the first network entity may be configured to: transmit the first indication of the group ID to the second network entity in order to cause the second network entity to transmit the group ID to the at least one second UE. For example, referring to FIG. 5, to identify the at least one second UE (UE2 504) via the second network entity (cell2 514), the first network entity (cell1 512) may be configured to transmit, at 524, the first indication of the group ID to the second network entity (cell2 514) in order to cause the second network entity (cell2 514) to transmit, at 528, the group ID to the at least one second UE (UE2 504).

In some aspects, the group ID may be transmitted to the at least one second UE via DCI. For example, referring to FIG. 5, when the second network entity (cell2 514) transmits, at 528 the group ID to the second UE (UE2 504), the group ID may be transmitted to the at least one second UE (UE2 504) via DCI.

In some aspects, the DCI may be scrambled with one or more of: a C-RNTI, a TC-RNTI, or a paging RNTI. For example, referring to FIG. 5, when the second network entity (cell2 514) transmits, at 528, the group ID to the second UE (UE2 504) through DCI, the DCI may be scrambled with one or more of: a C-RNTI, a TC-RNTI, or a paging RNTI.

In some aspects, the scrambling sequence for a PDSCH between the first UE and the at least one second UE is based on at least one of: the group ID or a combination of the group ID and a source ID associated with the first UE, or a common sequence known to the first UE and the at least one second UE. For example, referring to FIG. 5, the scrambling sequence for a PDSCH between the first UE (UE1 502) and the at least one second UE (e.g., UE2 504) may be based on at least one of: the group ID (at 520 and 524) or a combination of the group ID and a source ID associated with the first UE (UE1 502), or a common sequence known to the first UE (UE1 502) and the at least one second UE (UE2 504).

At 908, the first network entity may receive, in response to a change of a serving entity of the at least one second UE from the second network entity to a third network entity, a third indication of the change of the serving entity from the second network entity. For example, referring to FIG. 5, the first network entity (cell1 512) may receive, at 534, in response to a change of a serving entity of the at least one second UE (UE2 504) from the second network entity to another network entity (e.g., UE4 508), a third indication of the change of the serving entity from the second network entity (cell2 514). In some aspects, 908 may be performed by the Uu-based sidelink communication component 199.

At 910, the first network entity may transmit the second indication of the group ID to the at least one second UE via the third network entity. For example, referring to FIG. 5, the first network entity (cell1 512) may transmit, at 536, the second indication of the group ID to the at least one second UE (UE2 504) via the other network entity (cell4 518). In some aspects, 910 may be performed by the Uu-based sidelink communication component 199.

At 912, the first network entity may receive, from the first UE, an update indication that indicates an addition of a third UE to the group of UEs. For example, referring to FIG. 4, the first network entity (cell1 412) may receive, from the first UE (UE1 402), an update indication that indicates an addition of a third UE (UE3 406) to the group of UEs. In some aspects, 912 may be performed by the Uu-based sidelink communication component 199.

At 914, the first network entity may transmit the first indication of the group ID to a third network entity associated with the third UE within a set of preconfigured network entities. For example, referring to FIG. 4, the first network entity (cell1 412) may transmit the first indication of the group ID to a third network entity (cell3 416) associated with the third UE (UE3 406) within a set of preconfigured network entities. In some aspects, 914 may be performed by the Uu-based sidelink communication component 199.

In some aspects, the third network entity is a serving entity of the third UE. For example, referring to FIG. 5, the third network entity (cell3 516) may be a serving entity of the third UE (UE3 506). Referring to FIG. 4, the third network entity (cell3 416) may be a serving entity of the third UE (UE3 406).

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include a cellular baseband processor 1024 (also referred to as a modem) coupled to one or more transceivers 1022 (e.g., cellular RF transceiver). The cellular baseband processor 1024 may include on-chip memory 1024′. In some aspects, the apparatus 1004 may further include one or more subscriber identity modules (SIM) cards 1020 and an application processor 1006 coupled to a secure digital (SD) card 1008 and a screen 1010. The application processor 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor 1024 communicates through the transceiver(s) 1022 via one or more antennas 1080 with the UE 104 and/or with an RU associated with a network entity 1002. The cellular baseband processor 1024 and the application processor 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor 1024 and the application processor 1006 are each responsible for general processing, including the execution of software stored on the computer-readable medium/memory. The software, when executed by the cellular baseband processor 1024/application processor 1006, causes the cellular baseband processor 1024/application processor 1006 to perform the various functions described supra. The computer-readable medium/memory may also be used for storing data that is manipulated by the cellular baseband processor 1024/application processor 1006 when executing software. The cellular baseband processor 1024/application processor 1006 may be a component of the UE 350 and may include the memory 360 and/or at least one of the TX processor 368, the RX processor 356, and the controller/processor 359. In one configuration, the apparatus 1004 may be a processor chip (modem and/or application) and include just the cellular baseband processor 1024 and/or the application processor 1006, and in another configuration, the apparatus 1004 may be the entire UE (e.g., see UE 350 of FIG. 3) and include the additional modules of the apparatus 1004.

As discussed supra, the component 198 may be configured to transmit, for a first network entity, an indication of a group ID associated with communication between a group of UEs, where the group of UEs includes the first UE and at least one second UE, and the group ID is associated with an identification of the at least one second UE by the first network entity via a second network entity; and communicate, based on the group ID, with the at least one second UE through a Uu connection via the first network entity and the second network entity. The component 198 may be further configured to perform any of the aspects described in connection with the flowcharts in FIG. 6 and FIG. 7, and/or performed by the UE 502 in FIG. 5. The component 198 may be within the cellular baseband processor 1024, the application processor 1006, or both the cellular baseband processor 1024 and the application processor 1006. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1004 may include a variety of components configured for various functions. In one configuration, the apparatus 1004, and in particular the cellular baseband processor 1024 and/or the application processor 1006, includes means for transmitting, for a first network entity, an indication of a group ID associated with communication between a group of UEs, where the group of UEs includes the first UE and at least one second UE, and the group ID is associated with an identification of the at least one second UE by the first network entity via a second network entity, and means for communicating, based on the group ID, with the at least one second UE through a Uu connection via the first network entity and the second network entity. The apparatus 1004 may further include means for performing any of the aspects described in connection with the flowcharts in FIG. 6 and FIG. 7, and/or aspects performed by the UE 502 in FIG. 5. The means may be the component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

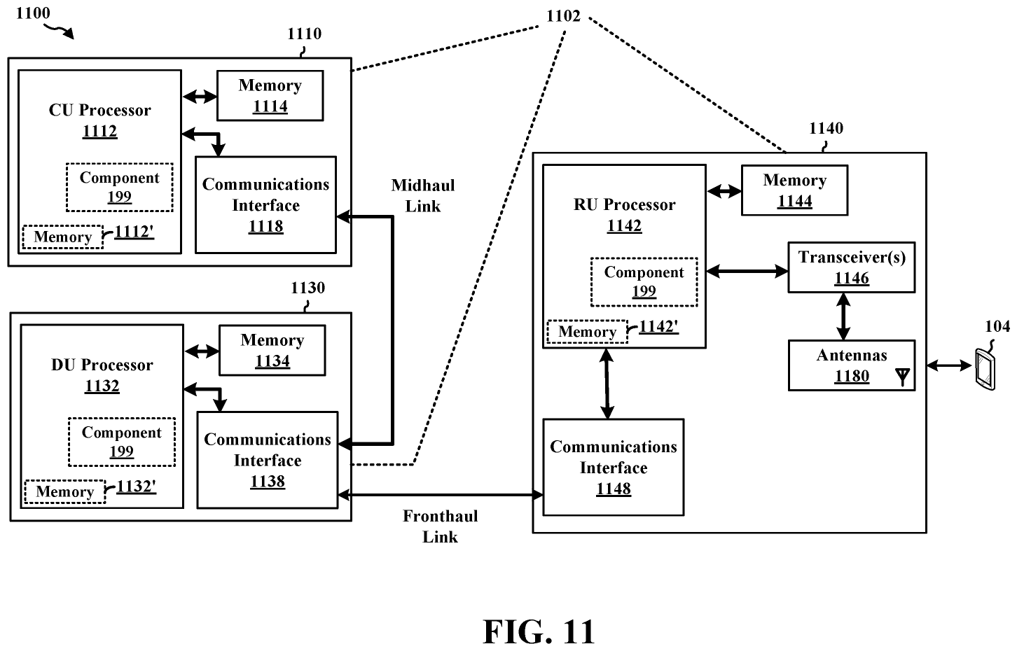

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include a CU processor 1112. The CU processor 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include a DU processor 1132. The DU processor 1132 may include on-chip memory 1132′. In some aspects, the DU 1130 may further include additional memory modules 1134 and a communications interface 1138. The DU 1130 communicates with the RU 1140 through a fronthaul link. The RU 1140 may include an RU processor 1142. The RU processor 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive, from a first UE, a first indication of a group ID associated with the first communication between a group of UEs, where the group of UEs includes the first UE and at least one second UE, and the group ID is associated with an identification of the at least one second UE by the first network entity via a second network entity; and transmit, for the second network entity, a second indication of the group ID, where the second indication of the group ID is associated with second communication between the first UE and the at least one second UE through a Uu connection via the first network entity and the second network entity. The component 199 may be further configured to perform any of the aspects described in connection with the flowcharts in FIG. 8 and FIG. 9, and/or performed by the cell 512 in FIG. 5. The component 199 may be within one or more processors of one or more of the CU 1110, DU 1130, and the RU 1140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1102 may include a variety of components configured for various functions. In one configuration, the network entity 1102 includes means for receiving, from a first UE, a first indication of a group ID associated with the first communication between a group of UEs, where the group of UEs includes the first UE and at least one second UE, and the group ID is associated with an identification of the at least one second UE by the first network entity via a second network entity, and means for transmitting, for the second network entity, a second indication of the group ID, where the second indication of the group ID is associated with second communication between the first UE and the at least one second UE through a Uu connection via the first network entity and the second network entity. The network entity 1102 may further include means for performing any of the aspects described in connection with the flowcharts in FIG. 8 and FIG. 9 . . . and/or aspects performed by the cell 512 in FIG. 5. The means may be the component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a first UE. The method may include transmitting, for a first network entity, an indication of a group ID associated with communication between a group of UEs, where the group of UEs includes the first UE and at least one second UE, and the group ID is associated with an identification of the at least one second UE by the first network entity via a second network entity; and communicating, based on the group ID, with the at least one second UE through a Uu connection via the first network entity and the second network entity. The method enables a UE to transmit a destination ID to its serving cell to establish a connected groupcast or unicast with UEs served by other cells. The method facilitates the connection among UEs served by different cells and improves the efficiency of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A . . . multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X. X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first UE. The method may include transmitting, for a first network entity, an indication of a group ID associated with communication between a group of UEs, where the group of UEs includes the first UE and at least one second UE, and the group ID is associated with an identification of the at least one second UE by the first network entity via a second network entity; and communicating, based on the group ID, with the at least one second UE through a Uu connection via the first network entity and the second network entity.

Aspect 2 is the method of aspect 1, where the indication of the group ID may be transmitted to the first network entity via a MAC-CE or an RRC message.

Aspect 3 is the method of aspect 2, where, prior to the group ID being associated with the identification of the at least one second UE, the first network entity may be associated with the identification of the second network entity.

Aspect 4 is the method of any of aspects 1 to 3, where the identification of the second network entity may be associated with: a first determination of a current location of the first UE, a second determination of, based on the current location of the first UE and a sidelink range of the first UE, a region for the at least one second UE, and the identification of, based on the region, the second network entity.

Aspect 5 is the method of any of aspects 1 to 3, where the identification of the second network entity may be associated with the identification of the second network entity from a set of preconfigured network entities.

Aspect 6 is the method of aspect 5, where the identification of the second network entity from the set of preconfigured network entities may be based on a maximum range of the first UE.

Aspect 7 is the method of any of aspects 1 to 3, where the identification of the at least one second UE by the first network entity via the second network entity may be associated with: the transmission of the indication of the group ID to the second network entity to cause the second network entity to transmit the group ID to the at least one second UE.

Aspect 8 is the method of aspect 7, where the group ID may be transmitted to the at least one second UE via DCI.

Aspect 9 is the method of aspect 8, where the DCI may be scrambled with one or more of: a C-RNTI, a TC-RNTI, or a paging RNTI.

Aspect 10 is the method of any of aspects 1 to 3, where the scrambling sequence for a PDSCH between the first UE and the at least one second UE may be based on at least one of: the group ID or a combination of the group ID and a source ID associated with the first UE, or a common sequence known to the first UE and the at least one second UE.

Aspect 11 is the method of any of aspects 1 to 3, where communicating with the at least one second UE via the first network entity and the second network entity may include: communicating, in response to a change of a serving entity of the at least one second UE from the second network entity to a third network entity, with the at least one second UE via the first network entity and the third network entity.

Aspect 12 is the method of any of aspects 1 to 3, where the method may further include: transmitting, to the first network entity, an update indication that indicates an addition of a third UE to the group of UEs, where the update indication is associated with a transmission of the indication of the group ID from the first network entity to a third network entity associated with the third UE within a set of preconfigured network entities.

Aspect 13 is the method of aspect 12, where the third network entity may be a serving entity of the third UE.

Aspect 14 is an apparatus for wireless communication at a UE, including: a memory; and at least one processor coupled to the memory and, based at least in part on information stored in the memory, the at least one processor is configured to perform the method of any of aspects 1-13.

Aspect 15 is the apparatus of aspect 14, further including at least one of a transceiver or an antenna coupled to the at least one processor and configured to transmit the indication of the group ID.

Aspect 16 is an apparatus for wireless communication including means for implementing the method of any of aspects 1-13.

Aspect 17 is a computer-readable medium (e.g., a non-transitory computer-readable medium) storing computer executable code, where the code when executed by a processor causes the processor to implement the method of any of aspects 1-13.

Aspect 18 is a method of wireless communication at a first network entity. The method may include receiving, from a first UE, a first indication of a group ID associated with the first communication between a group of UEs, where the group of UEs includes the first UE and at least one second UE, and the group ID is associated with an identification of the at least one second UE by the first network entity via a second network entity; and transmitting, for the second network entity, a second indication of the group ID, where the second indication of the group ID is associated with second communication between the first UE and the at least one second UE through a Uu connection via the first network entity and the second network entity.

Aspect 19 is the method of aspects 18, where the first indication of the group ID may be identical to the second indication of the group ID.

Aspect 20 is the method of aspects 18, where the first indication of the group ID may be different from the second indication of the group ID.

Aspect 21 is the method of aspects 18, where the first indication may be received from the first UE via a MAC-CE or an RRC message.

Aspect 22 is the method of aspects 21, where, prior to the group ID being associated with the identification of the at least one second UE, the first network entity may be configured to identify the second network entity.

Aspect 23 is the method of aspects 22, where the second network entity may be identified by the first network entity by: determining a current location of the first UE, determining, based on the current location of the first UE and a sidelink range of the first UE, a region for the at least one second UE, and identifying, based on the region, the second network entity.

Aspect 24 is the method of aspects 22, where identifying the second network entity may include: identifying the second network entity from a set of preconfigured network entities.

Aspect 25 is the method of aspects 24, where the second network entity may be identified from the set of preconfigured network entities based on the maximum range of the first UE.

Aspect 26 is the method of aspects 22, where identifying the at least one second UE via the second network entity may include: transmitting the first indication of the group ID to the second network entity in order to cause the second network entity to transmit the group ID to the at least one second UE.

Aspect 27 is the method of aspects 26, where the group ID may be transmitted to the at least one second UE via DCI.

Aspect 28 is the method of aspects 27, where the DCI may be scrambled with one or more of: a C-RNTI, a TC-RNTI, or a paging RNTI.

Aspect 29 is the method of any of aspects 22 to 28, where the scrambling sequence for a PDSCH between the first UE and the at least one second UE may be based on at least one of: the group ID or a combination of the group ID and a source ID associated with the first UE, or a common sequence known to the first UE and the at least one second UE.

Aspect 30 is the method of any of aspects 22 to 29, where the method may further include: receiving, in response to a change of a serving entity of the at least one second UE from the second network entity to a third network entity, a third indication of the change of the serving entity from the second network entity; and transmitting the second indication of the group ID to the at least one second UE via the third network entity.

Aspect 31 is the method of any of aspects 22 to 29, where the method may further include: receiving, from the first UE, an update indication that indicates an addition of a third UE to the group of UEs; and transmitting the first indication of the group ID to a third network entity associated with the third UE within a set of preconfigured network entities.

Aspect 32 is the method of aspects 31, where the third network entity may be a serving entity of the third UE.

Aspect 33 is an apparatus for wireless communication at a network entity, including: a memory; and at least one processor coupled to the memory and, based at least in part on information stored in the memory, the at least one processor is configured to perform the method of any of aspects 18-32.

Aspect 34 is the apparatus of aspect 33, further including at least one of a transceiver or an antenna coupled to the at least one processor and configured to receive the first indication of the group ID.

Aspect 35 is an apparatus for wireless communication including means for implementing the method of any of aspects 18-32.

Aspect 36 is a computer-readable medium (e.g., a non-transitory computer-readable medium) storing computer executable code, where the code when executed by a processor causes the processor to implement the method of any of aspects 18-32.

What is claimed is:

1. An apparatus for wireless communication at a first user equipment (UE), comprising:
memory; and
at least one processor coupled to the memory and, based at least in part on information stored in the memory, the at least one processor is configured to:
transmit, for a first network entity, an indication of a group identifier (ID) associated with communication between a group of UEs, wherein the group of UEs includes the first UE and at least one second UE, and the group ID is associated with an identification of the at least one second UE by the first network entity via a second network entity; and
communicate, based on the group ID, with the at least one second UE through a UE-Universal Mobile Telecommunications System (UMTS) connection via the first network entity and the second network entity.

2. The apparatus of claim 1, further comprising a transceiver coupled to the at least one processor, wherein, to transmit the indication of the group ID, the at least one processor is configured to transmit, via the transceiver, the indication of the group ID to the first network entity via a medium access control (MAC)-control element (MAC-CE) or a radio resource control (RRC) message.

3. The apparatus of claim 2, wherein, prior to the group ID being associated with the identification of the at least one second UE, the first network entity is associated with the identification of the second network entity.

4. The apparatus of claim 3, wherein the identification of the second network entity is associated with:
a first determination of a current location of the first UE,
a second determination of, based on the current location of the first UE and a sidelink range of the first UE, a region for the at least one second UE, and
the identification of, based on the region, the second network entity.

5. The apparatus of claim 3, wherein the identification of the second network entity is associated with:
the identification of the second network entity from a set of preconfigured network entities.

6. The apparatus of claim 5, wherein the identification of the second network entity from the set of preconfigured network entities is based on a maximum range of the first UE.

7. The apparatus of claim 3, wherein the identification of the at least one second UE by the first network entity via the second network entity is associated with:
a transmission of the indication of the group ID to the second network entity to cause the second network entity to transmit the group ID to the at least one second UE.

8. The apparatus of claim 7, wherein the group ID is configured to be transmitted to the at least one second UE via downlink control information (DCI).

9. The apparatus of claim 8, wherein the DCI is scrambled with one or more of:
a cell radio network temporary identifier (C-RNTI),
a temporary C-RNTI (TC-RNTI), or
a paging RNTI.

10. The apparatus of claim 3, wherein a scrambling sequence for a physical data shared channel (PDSCH) between the first UE and the at least one second UE is based on at least one of:
the group ID or a combination of the group ID and a source ID associated with the first UE, or
a common sequence known to the first UE and the at least one second UE.

11. The apparatus of claim 3, wherein, to communicate with the at least one second UE via the first network entity and the second network entity, the at least one processor is configured to:
communicate, in response to a change of a serving entity of the at least one second UE from the second network entity to a third network entity, with the at least one second UE via the first network entity and the third network entity.

12. The apparatus of claim 3, wherein the at least one processor is further configured to:
transmit, to the first network entity, an update indication that indicates an addition of a third UE to the group of UEs, wherein the update indication is associated with a transmission of the indication of the group ID from the first network entity to a third network entity associated with the third UE within a set of preconfigured network entities.

13. The apparatus of claim 12, wherein the third network entity is a serving entity of the third UE.

14. An apparatus for wireless communication at a first network entity, comprising:
memory; and
at least one processor coupled to the memory and, based at least in part on information stored in the memory, the at least one processor is configured to:
receive, from a first user equipment (UE), a first indication of a group identifier (ID) associated with first communication between a group of UEs, wherein the group of UEs includes the first UE and at least one second UE, and the group ID is associated with an identification of the at least one second UE by the first network entity via a second network entity; and
transmit, for the second network entity, a second indication of the group ID, wherein the second indication of the group ID is associated with second communication between the first UE and the at least one second UE through a UE-Universal Mobile Telecommunications System (UMTS) connection via the first network entity and the second network entity.

15. The apparatus of claim 14, further comprising a transceiver coupled to the at least one processor, wherein, to receive the first indication of the group ID, the at least one processor is configured to receive the first indication of the group ID via the transceiver, and wherein the first indication of the group ID is identical to the second indication of the group ID.

16. The apparatus of claim 14, wherein the first indication of the group ID is different from the second indication of the group ID.

17. The apparatus of claim 14, wherein, to receive the first indication, the at least one processor is configured to receive the first indication from the first UE via a medium access control (MAC)-control element (MAC-CE) or a radio resource control (RRC) message.

18. The apparatus of claim 17, wherein, prior to the group ID being associated with the identification of the at least one second UE, the at least one processor is configured to identify the second network entity.

19. The apparatus of claim 18, wherein, to identify the second network entity, the at least one processor is configured to:
determine a current location of the first UE,
determine, based on the current location of the first UE and a sidelink range of the first UE, a region for the at least one second UE, and
identify, based on the region, the second network entity.

20. The apparatus of claim 18, wherein, to identify the second network entity, the at least one processor is configured to:
identify the second network entity from a set of preconfigured network entities.

21. The apparatus of claim 20, wherein, to identify the second network entity, the at least one processor is configured to identify the second network entity from the set of preconfigured network entities based on a maximum range of the first UE.

22. The apparatus of claim 18, wherein, to identify the at least one second UE via the second network entity, the at least one processor is configured to:
transmit the first indication of the group ID to the second network entity in order to cause the second network entity to transmit the group ID to the at least one second UE.

23. The apparatus of claim 22, wherein the group ID is configured to be transmitted to the at least one second UE via downlink control information (DCI).

24. The apparatus of claim 23, wherein the DCI is scrambled with one or more of:
a cell radio network temporary identifier (C-RNTI),
a temporary C-RNTI (TC-RNTI), or
a paging RNTI.

25. The apparatus of claim 18, wherein a scrambling sequence for a physical data shared channel (PDSCH) between the first UE and the at least one second UE is based on at least one of:
the group ID or a combination of the group ID and a source ID associated with the first UE, or
a common sequence known to the first UE and the at least one second UE.

26. The apparatus of claim 18, wherein the at least one processor is further configured to:
receive, in response to a change of a serving entity of the at least one second UE from the second network entity to a third network entity, a third indication of the change of the serving entity from the second network entity; and
transmit the second indication of the group ID to the at least one second UE via the third network entity.

27. The apparatus of claim 18, wherein the at least one processor is further configured to:
receive, from the first UE, an update indication that indicates an addition of a third UE to the group of UEs; and
transmit the first indication of the group ID to a third network entity associated with the third UE within a set of preconfigured network entities.

28. The apparatus of claim 27, wherein the third network entity is a serving entity of the third UE.

29. A method of wireless communication at a first user equipment (UE), comprising:
transmitting, for a first network entity, an indication of a group identifier (ID) associated with communication between a group of UEs, wherein the group of UEs includes the first UE and at least one second UE, wherein the group ID is associated with an identification of the at least one second UE by the first network entity via a second network entity; and
communicating, based on the group ID, with the at least one second UE through a UE-Universal Mobile Telecommunications System (UMTS) connection via the first network entity and the second network entity.

30. A method of wireless communication at a first network entity, comprising:
receiving, from a first user equipment (UE), a first indication of a group identifier (ID) associated with first communication between a group of UEs, wherein the group of UEs includes the first UE and at least one second UE, wherein the group ID is associated with an identification of the at least one second UE by the first network entity via a second network entity; and
transmitting, for the second network entity, a second indication of the group ID, wherein the second indication of the group ID is associated with second communication between the first UE and the at least one second UE through a UE-Universal Mobile Telecommunications System (UMTS) connection via the first network entity and the second network entity.
